(19) United States
(12) Patent Application Publication
(10) Pub. No.: US 2005/0088849 A1
(43) Pub. Date: Apr. 28, 2005

(54) LIGHT EFFECT CAR TREADING CUSHION

(76) Inventor: Hsu Feng Cheng, Taipei (TW)

Correspondence Address: Hsu Feng Cheng, 235 Chung - Ho, Box 8-24, Taipei, TW

(21) Appl. No.: 10/689,966

(22) Filed: Oct. 22, 2003

(51) Int. Cl. B60Q 1/00

(52) U.S. Cl. 362/488

(57) ABSTRACT

A car treading cushion comprises a rubber plate made by non-transparent rubber material. A receiving slot is formed at the rubber plate. The receiving slot is formed by a transparent rubber material and a periphery of the receiving slot is enclosed by a plurality of transparent sections. A bottom of each transparent section has a groove and a front surface of the transparent section opposite to the bottom of the transparent section has a cambered surface. The circuit board has a battery and a vibration sensing switch. The circuit board is embedded into the receiving slot of the rubber plate. The circuit board is conductive through a predetermined time period due to vibration. When the predetermined conductive time period is elapsed, the power will be interrupted. The circuit board is installed with a plurality of light emitting diode lamps in the grooves of the respective transparent sections.

### FIELD OF THE INVENTION

The present invention relates to car treading cushions, and particularly to a light effect car treading cushion which can provide light effect so as to present a beautiful outlook and provide a convenience for finding some object in the lower section of the interior of the car.

### BACKGROUND OF THE INVENTION

Prior art car treading cushions are purely made by a rubber plate or a fiber plate. Other than textures on the plate, no means are formed thereon, especially, no light effect is presented on the prior art car treading cushion. Thereby, it is dull. Moreover, generally, the lower section of the interior of car is generally dark, when some objects fall to the ground of the interior of the car, the user will feel inconvenient to pick up the falling objects since no illumination is provided.

### SUMMARY OF THE INVENTION

Accordingly, the primary object of the present invention is to provide a car treading cushion which comprises a rubber plate made by non-transparent rubber material. A receiving slot is formed at the rubber plate. The receiving slot is formed by a transparent rubber material and a periphery of the receiving slot is enclosed by a plurality of transparent sections. A bottom of each transparent section has a groove and a front surface of the transparent section opposite to the bottom of the transparent section has a cambered surface. The circuit board has a battery and a vibration sensing switch. The circuit board is embedded into the receiving slot of the rubber plate. The circuit board is conductive through a predetermined time period due to vibration. When the predetermined conductive time period is elapsed, the power will be interrupted. The circuit board is installed with a plurality of light emitting diode lamps in the grooves of the respective transparent sections.

The various objects and advantages of the present invention will be more readily understood from the following detailed description when read in conjunction with the appended drawing.

### BRIEF DESCRIPTION OF THE DRAWINGS

FIG. 1 is a bottom exploded perspective view of the present invention.

FIG. 2 shows a front perspective view of the present invention and a cross section view along ling A-A of FIG. 2.

### DETAILED DESCRIPTION OF THE PREFERRED EMBODIMENTS

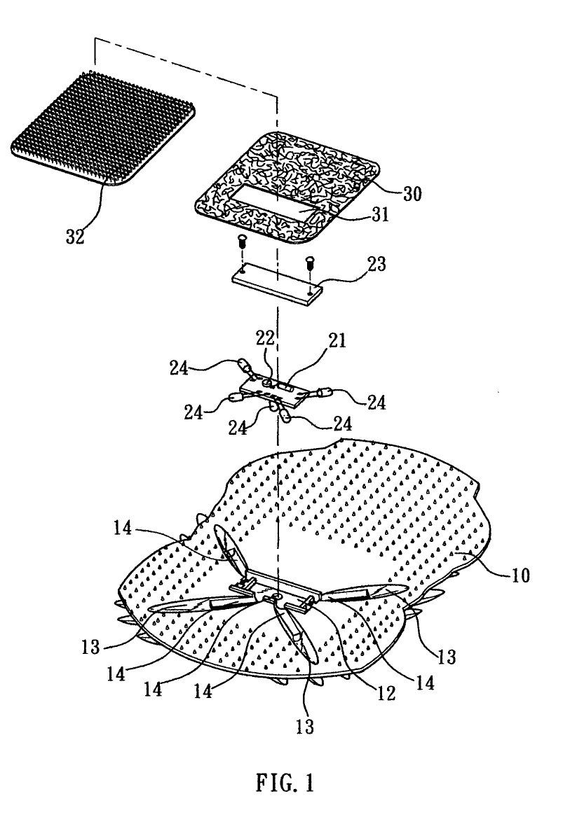

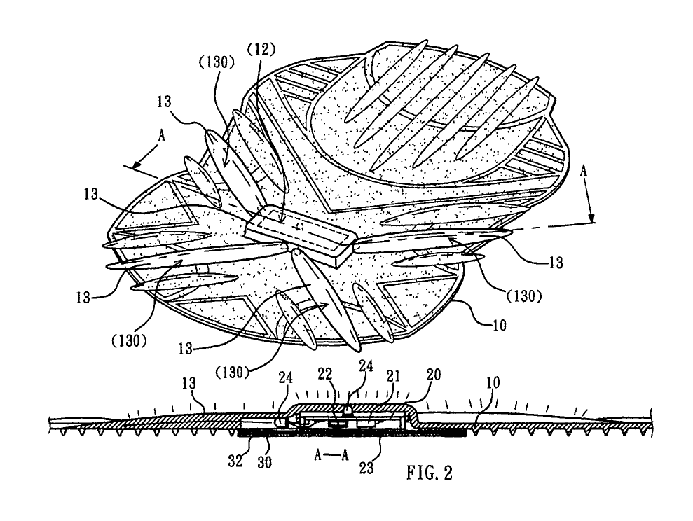

Referring to FIGS. 1 and 2, the car treading cushion of the present invention is illustrated. The car treading cushion includes a rubber plate 10, a circuit board 20, a cover 23, a male sticky sheet 32, and a female sticky sheet 30.

The rubber plate 10 is made by non-transparent rubber material. A receiving slot 12 is formed at a predetermined position of the rubber plate 10. The receiving slot 12 is formed by a transparent rubber material and a periphery of the receiving slot 12 is enclosed by a plurality of transparent sections 13. A bottom of each transparent section 13 has a groove 14 and a front surface of the transparent section 13 opposite to the bottom of the transparent section 13 has a cambered surface 130.

The circuit board 20 has a battery 22 and a vibration sensing switch 21. The circuit board 20 is embedded into the receiving slot 12 of the rubber plate 10 and is then sealed by a cover 23. The circuit board 20 is conductive through a predetermined time period due to vibration. When the predetermined conductive time period is elapsed, the power will be interrupted. The circuit board 20 is installed with a plurality of light emitting diode lamps 24. An end of each light emitting diode lamp 24 is embedded into the groove 14 of one respective transparent section 13. Thereby, the light from the light emitting diode lamps 24 is radiated out from the transparent sections 13. Thus the surface of the rubber plate 10 has light effect.

The female sticky sheet 30 is formed with a hollow recess 31 with a configuration corresponding to the receiving slot 12 of the rubber plate 10. The female sticky sheet 30 is seamed and fixed to a surface of the rubber plate 10.

The male sticky sheet 32 is stuck to the upper surface of the female sticky sheet 30 for sealing and protecting the elements of the circuit board 20. The male sticky sheet 32 and female sticky sheet 30 are detachable for updating the battery 22.

In the present invention, the rubber plate 10 can be made integrally by injection molding and the holes of placing the transparent sections 13 are left. The transparent sections 13 are adhered to the rubber plate 10 by using high frequency adhering machine. A dual injection device can be used to inject the rubber plate 10 and the transparent sections 13 at the same time. Then the female sticky sheet 30 and circuit board 20 are seamed to the receiving slot 12 of the rubber plate 10. Then the male sticky sheet 32 seals upon the female sticky sheet 30.

The present invention can be placed in the bottom of a car. When the user treads upon the car treading cushion, the car treading cushion will vibrate. The vibration sensing switch 21 of the circuit board 20 will cause the power to conduct so as to actuate the light emitting diode lamps 24 of the circuit board 20. Further, a flash time period can be set at the initial state, and then the light emitting diode lamps do not flash. When a time period elapses, the power will be interrupted.

When each light emitting diode lamp 24 lights up, since each transparent section 13 is transparent. It can act as a light beam so as to transfer light to the distal end. Because of the effect of the cambered surface 130, the light emission is like a light beam or light emitting surface so as to present a beautiful light effect. Moreover, since generally, the bottom of the inside of the car is dark, the present invention can provide light to the portion. This is convenient when the user picks up some objects.

The vibration sensing switch of the present invention can be a sound controlled switch or a manual controlled switch so as to control the power by sound or manual operation, respectively.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A car treading cushion comprising:
a rubber plate made by non-transparent rubber material; a receiving slot enclosed by transparent material being formed at a predetermined position of the rubber plate; a periphery of the receiving slot being enclosed by a plurality of transparent sections; a bottom surface of each transparent section having a groove and a front surface of the transparent section opposite to the bottom of the transparent section having a cambered surface; and
a circuit board having a battery and a vibration sensing switch; the circuit board being embedded into the receiving slot of the rubber plate and being then sealed by a cover; the circuit board being conductive through a predetermined time period due to vibration; when the predetermined conductive time period is elapsed, the power will be interrupted; the circuit board being installed with a plurality of light emitting diode lamps; an end of each light emitting diode lamp being embedded into the groove of one respective transparent section; thereby, the light emitted from the light emitting diode lamps is radiated out from the transparent sections; and the surface of the rubber plate present light effect.

2. The car treading cushion as claimed in claim 1, further comprising
a female sticky sheet being formed with a hollow recess with a configuration corresponding to the receiving slot of the rubber plate; the female sticky sheet is seamed and fixed to a surface of the rubber plate; and
a male sticky sheet being stuck to an upper surface of the female sticky sheet for sealing and protecting the elements of the circuit board; the male sticky sheet and female sticky sheet being detachable for updating the battery.

2. The car treading cushion as claimed in claim 1, wherein the vibration sensing switch is a sound controlled switch so as to control the power by sound.

3. The car treading cushion as claimed in claim 1, wherein the vibration sensing switch is a manual controlled switch so as to control the power by manual operation.
